(19) United States
(12) Patent Application Publication
(10) Pub. No.: US 2013/0067062 A1
(43) Pub. Date: Mar. 14, 2013

(54) Correlation of Users to IP Address Lease Events

(71) Applicants: Vithalprasad J. Gaitonde, Hyderabad (IN); Kasi Sambandam, Hyderabad (IN); Nageswara Rao Vankayala, Hyderabad (IN)

(72) Inventors: Vithalprasad J. Gaitonde, Hyderabad (IN); Kasi Sambandam, Hyderabad (IN); Nageswara Rao Vankayala, Hyderabad (IN)

(73) Assignee: Microsoft Corporation, Redmond, WA (US)

(21) Appl. No.: 13/229,976

(22) Filed: Sep. 12, 2011

(51) Int. Cl. G06F 15/173

(52) U.S. Cl. 709/224

(57) ABSTRACT

Techniques for correlation of users to IP address lease events are described herein. In one or more embodiments, an audit system is provided to collect IP address lease events from a DHCP server and authentication data from one or more sources of authentication data. The audit system may store the collected data in a common data store. The common data store may be searched to correlate the IP address lease events with authentication data. In this manner, a comprehensive record of the computers or devices used by a user within a given time period can be established through correlation of the historical IP address lease information from the DHCP server with the user login information from an authentication source. This may occur by matching events using timestamps of the events and the IP address and/or other common elements between two event sources.

### BACKGROUND

In certain network forensics scenarios, it may be useful to establish a trail of the computers/devices used by a user within a specific historical time period. In an environment where internet protocol (IP) addresses are dynamically assigned using the dynamic host configuration protocol (DHCP), the IP address assignment to devices on a network is temporary and can change over time. Hence, IP addresses do not necessarily uniquely identify a computer or device. A host name assigned to a computer or device can also be changed and hence cannot be relied upon for unique device/computer identification. Thus, establishing a comprehensive record or trail of the computers or devices used by a user within a specific historical time period, complete with IP address, host name, and MAC (Media Access Control)/DUID (DHCP Unique Identifier) address of a computer or device may be difficult or impossible if based solely on IP lease events.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for correlation of users to IP address lease events are described herein. A DHCP server can be instrumented to maintain or log historical IP address lease events which contain IP addresses, MAC addresses/DUID and host names. An authentication server or other source of authentication data may log events for user authentication, which also identify the IP address from which an authentication request was received. In one or more embodiments, an audit system is provided to collect IP address lease events from the DHCP server and authentication data from one or more authentication services. The audit system may store the collected data in a common data store. The common data store may be searched to correlate the IP address lease events with authentication data. In this manner, a comprehensive record of the computers or devices used by a user within a given time period can be established through correlation of the historical IP address lease information from the DHCP server with the user login information from an authentication source. This may occur by matching events using timestamps of the events and the IP address and/or other common elements between two event sources (by using common host names/MAC addresses, etc.).

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example operating environment in accordance with one or more embodiments.

FIG. 2 is an illustration of an example system for correlation of users to IP address events in accordance with one or more embodiments.

FIG. 3 is an illustration of an example procedure for correlation of users to IP address lease events in accordance with one or more embodiments.

FIG. 4 is an illustration of another example procedure for correlation of users to IP address lease events in accordance with one or more embodiments.

FIG. 5 is an illustration of an example computing system that can be employed to implement techniques to correlate users to IP address lease events in one or more embodiments.

### DETAILED DESCRIPTION

### Overview

Establishing a comprehensive record or trail of the computers or devices used by a user within a specific historical time period, complete with IP address, host name, and MAC (Media Access Control) address may be difficult or impossible if based solely on IP lease events. This is so because both IP addresses and host names for a device may dynamically change over time and therefore cannot be reliably mapped to a particular user device based on a lease event log.

Techniques for correlation of users to IP address lease events are described herein. A DHCP server can be instrumented to maintain or log historical IP address lease events which contain IP address, MAC address/DUID, and host name. An authentication server or other source of authentication data may log events for user authentication, which also identify the IP address and/or other common elements corresponding to the authentication request that was received. An audit system is provided to collect IP address lease events from the DHCP server and authentication data from one or more authentication services. The audit system may provide an analysis tool that can be used to correlate the collected data. This enables a network administrator to search events for a given time frame and obtain results mapping a user/user account to particular devices identified by the IP address, MAC address, and/or host name.

In the following discussion, an example operating environment is first described that may employ the techniques described herein. Next, an example system is discussed to illustrate details of some aspects of techniques for correlating users to IP address lease events. Following this, an example procedure is discussed, which may be implemented in the example environment/system as well as other environments/systems. Consequently, performance of the procedures is not limited to the example environment/system and the example environment/system is not limited to performance of the example techniques. Lastly, details regarding example computing systems and devices are described that may be employed to implement one or more embodiments.

### Operating Environment

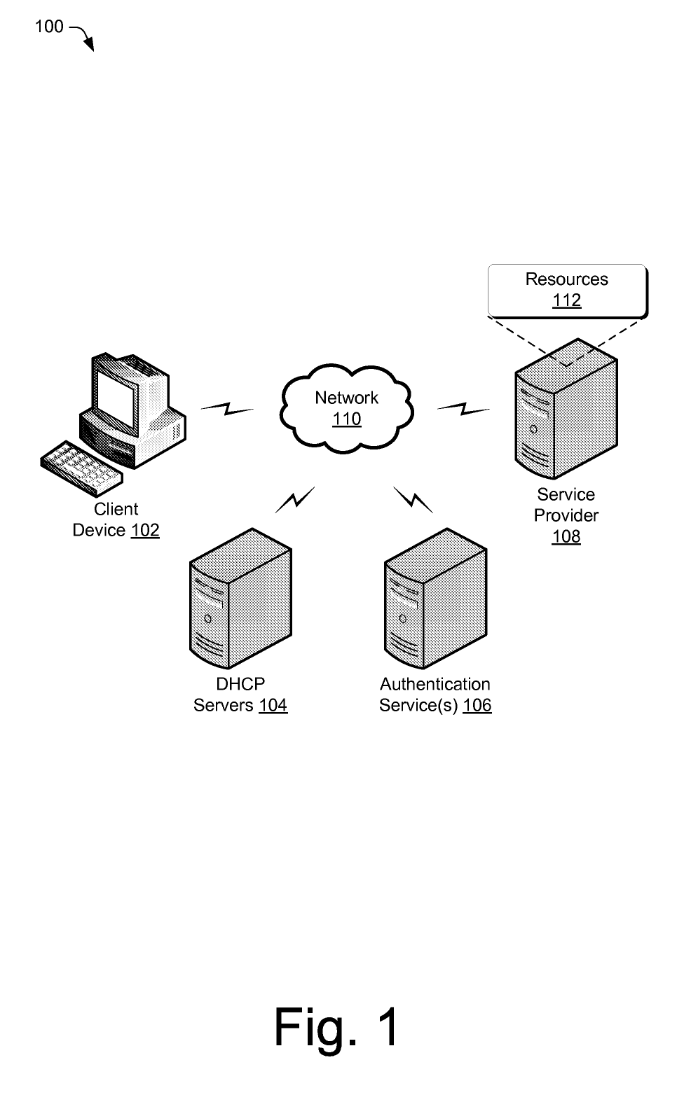

FIG. 1 is an illustration of an environment 100 in an example implementation that is operable to employ techniques described herein. The illustrated environment 100 includes a client device 102, one or more dynamic host configuration protocol (DHCP) servers 104, one or more authentication services 106, and a service provider 108 that are communicatively coupled via a network 110. The client device 102, one or more DHCP servers 104, one or more authentication services 106, and service provider 108 may be implemented by one or more computing devices and also may be representative of one or more entities.

A computing device may be configured in a variety of ways. For example, a computing device may be configured as a computer that is capable of communicating over the network 110, such as a desktop computer, a mobile station, an entertainment appliance, a set-top box communicatively coupled to a display device, a wireless phone, a game console, and so forth. Thus, the computing device may range from full resource devices with substantial memory and processor resources (e.g., personal computers, game consoles) to a low-resource device with limited memory and/or processing resources (e.g., traditional set-top boxes, hand-held game consoles). Additionally, although a single computing device is shown in some instances, the computing device may be representative of a plurality of different devices, such as multiple servers utilized to perform operations such as by the service provider 108 and/or authentication service 106, and so on.

Although the network 110 is illustrated as the Internet, the network may assume a wide variety of configurations. For example, the network 110 may include a wide area network (WAN), a local area network (LAN), a wireless network, a public telephone network, an intranet, and so on. Further, although a single network 110 is shown, the network 110 may be configured to include multiple networks.

The client device 102 may be configured with functionality to enable various communications over the network 110. For example, the client device 102 may include a browser or other suitable application to obtain and output webpages and/or other user interfaces from the service provider 108 over the network 110. The service provider 108 may manage various resources 112 that may be made accessible to clients over the network 110. Generally, resources 112 made accessible by a service provider 108 may include any suitable combination of services and/or content typically made available over a network by one or more providers. Some examples of services include, but are not limited to, a search service, an email service, an instant messaging service, an online productivity suite, and an authentication service to control access of clients to the resources 112. Content may include various combinations of text, multi-media streams, documents, application files, photos, audio/video files animations, images, web pages, web applications, device applications, content for display by a browser or other client application, and the like.

To interact in a network 110, the client device 102 may be configured to obtain and use an IP address that can be used for identification of the device as well as for locating the device and routing communications. The DHCP server 104 represents functionality to implement DHCP techniques to dynamically assign and manage IP addresses for clients. Although clients may be manually configured, the configuration is complex and may require a network administrator or other expert. The dynamic host configuration protocol (DHCP) is an automatic configuration protocol that can be used as an alternative to manually configuring devices with IP addresses. IP addresses may be leased for a period of time after which the lease expires, unless the client renews the address before expiry. The DHCP server 104 may be configured to maintain a log to track leases of IP address to different computers. For example, the log may match lease events (e.g., new lease start, lease renewal, lease expiration, etc.) for IP addresses to device identification information such as MAC addresses/DUID and host name. Thus, for a given time frame the DHCP log may map particular devices to corresponding IP addresses used for the device. In addition to providing IP addresses and logs, a DHCP server 104 also provides other configuration information used for advanced options, network details, peer information, and so forth.

A client device 102 may access resources 120 provided by a service provider 108 through user accounts with the provider. The authentication service 106 represent functionality operable to authenticate clients to access particular accounts and therefore gain access to corresponding resources 112. An authentication service 106 may be provided as a component of the service provider 108, as a standalone service as illustrated, by a third party provider, or otherwise. To access resources 112, a client device 102 may provide a username and password that is authenticated by the authentication service 106. When the authentication is successful (e.g., the client “is who they say they are”), the authentication service may pass a token to enable access to corresponding resources. A single authentication may correspond to one or more resources, such that authentication to a single account by a “single sign-on” may provide access to individual resources, resources from multiple service providers 108, and/or to an entire suite of resources available from a service provider 108.

In addition, the authentication service 106 may maintain a log of authentication data/events. The authentication log may associate sign-in, sign-out, resource access and other authentication events with account identifiers, credentials, access permissions, profile data and other data typically associated with user accounts. Authentication data/events may also be associated with IP addresses for devices used to sign-in and/or access resources 112. Thus, for a given time frame the authentication log may be used to map particular authenticated users and events to IP addresses. As discussed in greater detail below, a DHCP log and an authentication log (or comparable data) can be used to effectively correlate particular authenticated users to particular devices. This information can assist in forensic analysis, troubleshooting, and/or other network maintenance activities frequently conducted by a network administrator.

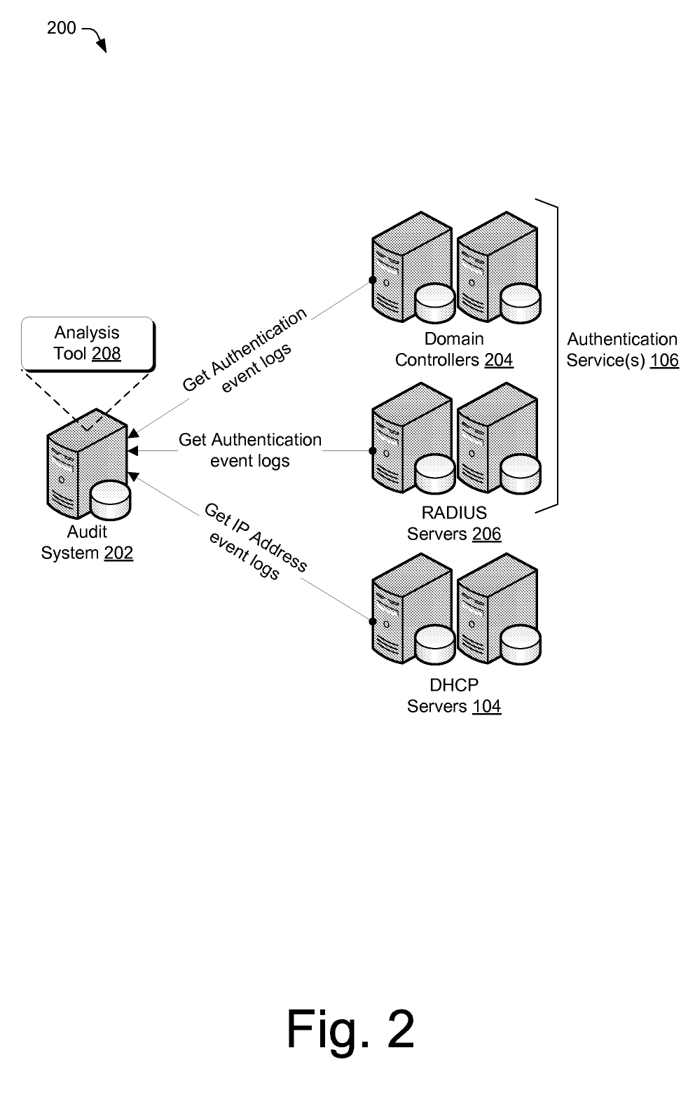

FIG. 2 depicts an example system 200 for correlation of users to IP address events in accordance with one or more embodiments. The system 200 includes an audit system 202, one or more authentication services 106 that are a source for authentication data, and a DHCP server 104 that is a source for IP address lease event data. In this example, the authentication services 106 are illustrated as including both domain controllers 204 and RADIUS servers 206. In general, any suitable sources of authentication data and IP address lease event data may be used for the correlation techniques described herein.

The audit system 202 represents functionality to collect and correlate log data from the various sources. This may occur in any suitable way. In at least some embodiments, the audit system 202 may poll various sources to obtain corresponding data. Additionally or alternatively, sources such as the DHCP server 104 and authentication services 106 may be configured to report log data to the audit system. Once collected, the audit system 202 may store the collected data in a common data store, such as an audit database. Data used for correlation described herein may also be accessed/retrieved on demand, such that the data is maintained in storage by respective DHCP server 104 and authentication services 106 and accessed/retrieved over a network 110.

The audit system 202 may expose an analysis tool 208 in the form of a web application, desktop application, or other suitable interface that enables access to review and manipulate the data stored in the data store or separately stored by different entities. For example, the analysis tool 208 may enable a network administer to conduct searches for particular IP addresses, MAC addresses, host names, user names, and the like. In response to such searches, the analysis tool 208 is configured to perform queries on available data to correlate the data from the different sources. It should be noted that audit system 202 may also perform some pre-correlation of the data so that computational time to respond to user searches on the database is reduced. Generally speaking, the correlation provides a trail of the computers or devices used by a user within a specific historical time period, complete with IP address, host name, and MAC (Media Access Control) address of a computer/device.

Accordingly, the audit system 202 can be implemented to correlate IP address lease events to authentication events in order to establish associations between user identity (user name/account) and device identity (MAC address/DUID). As represented in FIG. 2, this broadly speaking may involve three functional parts. The DHCP server 104 is instrumented to log IP address lease events (e.g., new lease, renew lease, release, and expire) to an event log for each IP address managed by the DHCP server 104. Each event may also be accompanied by a timestamp.

One or more authentication services 106, such as the example domain controllers 204 and/or RADIUS servers 206, log user authentication events to authentication logs. Along with the user information, authentication services 106 may also log one or more associated details of the user authentication like IP address, host name, and/or MAC address. At least some of these details as well as other suitable parameters may be common elements that can be used to cross reference between the DHCP log data and the authentication log data.

The centralized audit system 202 collects the events/logs from the DHCP server 104 and the authentication services 106 and stores the data in a common data store. Alternatively, the logs may be stored at respective sources and accessed on demand to perform searches and correlations. The data can be searched by IP address, MAC address host name, or user identity within a specific time period. The search may be performed by identifying one or more common elements and querying records in the data store to map the records one to another based on the common elements. In one example, timestamps and IP address can be used to correlate records for a given time frame.

An example search using IP address as the search criteria can be performed in the following manner. A search is input through the analysis tool 208 or otherwise to search for IP address lease events for a given IP address within a specific time period. If the first IP address lease event encountered for the specified IP address is a renew/release/expire event, then the IP address events are examined in reverse chronological order starting with the start time of the specified time period. This examination is performed to provide the IP address new lease event corresponding to the given IP address. The examination can be omitted if the first IP address lease event encountered in is a new lease event. Using the various new lease, release, and/or expire lease events determined for the specific IP address, different distinct lease period start and end values can be ascertained. Such different lease periods are referred to herein as “lease chunks.” Each ascertained lease chunk will have an IP address, MAC address and host name associated with it, picked up from the DHCP lease event logs. For each of the ascertained lease chunks (e.g., start and end times), a query is then made of the authentication events collected in the data store to find events that may match common elements, which could be one or more of the IP address, MAC address, or host name within the specified lease chunk. Using multiple different common elements for the search returns additional correlated information, which may not be obtained through a simple, direct search. For example, a search for a given IPv4 address may also return authentications that may have happened through IPv6 addresses because the host name matches between DHCP events and authentication events collected. Similarly for a given IPv4 address, authentication events that have occurred for a RADIUS server may be returned even though records are referenced in some cases using just the MAC address details, like for 802.11 interactions. This can be accomplished by correlating the MAC address information between DHCP and RADIUS servers.

The information collected from various sources is combined to create records mapping the IP address, MAC address and host name from IP address lease events/logs and user name/account ID from the authentication events/logs. In one approach, the records may be created in the form of a tuple (ordered list) such as: timestamp of authentication event, IP address, MAC address/DUID, host name, user name/account. Now, the records map particular users/user accounts to IP addresses. Of course records may be configured in any suitable way of which the example tuple is but one example.

A comparable correlation can be performed for each of the determined IP address lease chunks. Each tuple or other suitable record indicates that the identified user logged in and started a session at the recorded timestamp from a particular computing device, which is identified by the MAC address, IP address, and host name. Note that a similar process can be performed using a MAC address, host name, or user name as the initial search criteria. Further details regarding techniques for correlating users to IP address events can be found in relation to the following example procedures.

### Example Procedures

The following section describes example procedures for correlating users to IP address lease events in accordance with one or more embodiments. Aspects of each of the procedures described herein may be implemented in hardware, firmware, or software, or a combination thereof. The procedures are shown as a set of blocks that specify operations performed by one or more devices and are not necessarily limited to the orders shown for performing the operations by the respective blocks. In at least some embodiments, the procedures may be performed by a suitably configured computing device, such as the example audit system or DHCP servers described herein.

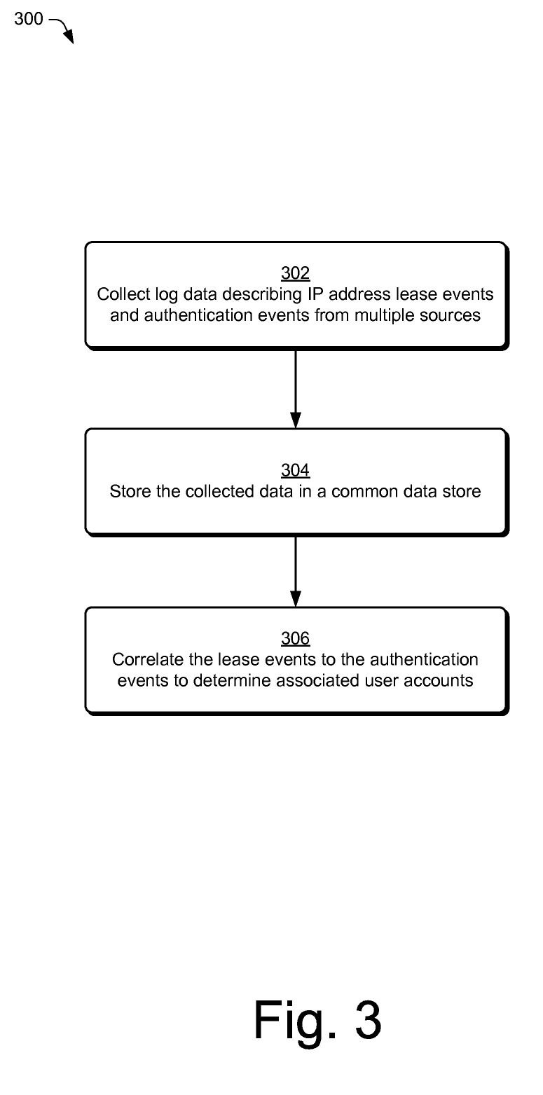

FIG. 3 depicts an example procedure 300 for correlating users to IP address lease events in accordance with one or more embodiments. In at least some embodiments, the procedure 300 may be performed by one or more computing devices, such as one or more servers used to implement the example audit system 202 described previously.

Data describing IP address lease events and authentication events is collected from multiple sources (block 302). For example, an audit system 202 may be implemented to collect log data from various sources as previously described. Various kinds of data can be collected from the various sources. This includes at least data describing IP address lease events and user authentication data.

The collected data is stored in a common data store (block 304). For instance, the audit system 202 may provide and manage a database of collected information. The audit system 202 may make the common database accessible over a network 110 to users such as network administrators. For instance, an audit tool 208 as mentioned above can be exposed to enable searches to be conducted for forensic analysis. The audit tool 208 may provide various controls, menus, and user interface instrumentalities to input and conduct searches on the database and to display results back to the user.

The IP lease events are correlated to the authentication events to determine associated user accounts (block 306). For example, responsive to searches, the audit system 202 can query records in the database for a selected time frame to map the records one to another based on the common elements. Common elements used for the correlation can include at least IP addresses, MAC addresses, user identity, and host names. In this manner information collected from various sources is combined to create records mapping the IP address, MAC address and host name from IP address lease events to usernames/accounts obtained from authentication events. The audit system 202 may also configure and output a user interface to display results of the search to a user.

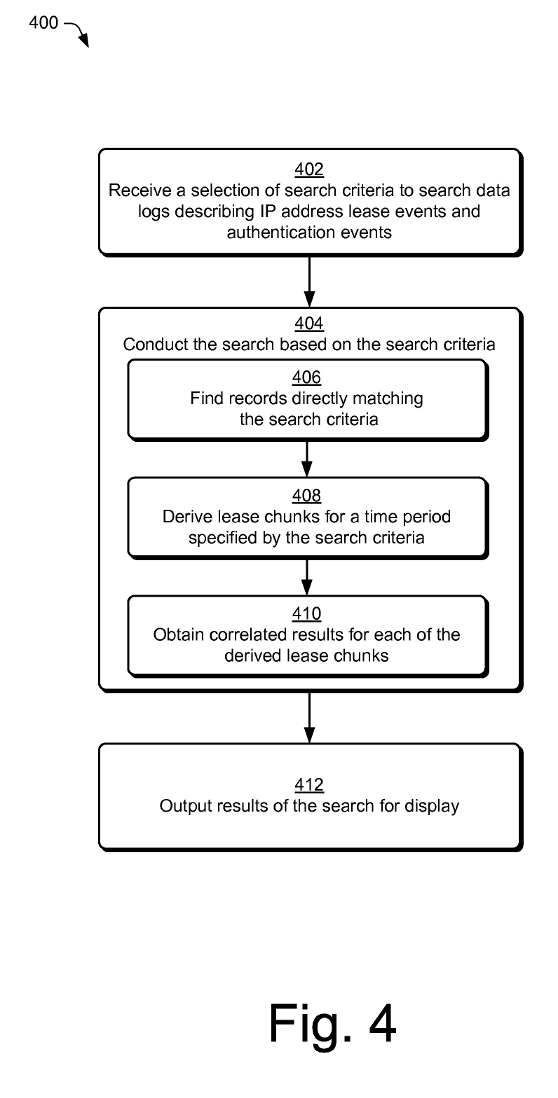

FIG. 4 depicts another example procedure 400 for correlating users to IP address lease events in accordance with one or more embodiments. In at least some embodiments, the procedure 400 may be performed by one or more computing devices, such as one or more servers used to implement the example audit system 202 described previously.

A selection is received of search criteria to search data logs describing IP lease event and authentication events (block 402). For example, the audit system 202 may be operable to output an analysis tool 208 that enables access to and retrieval of data logs from DHCP servers 104 and authentication services 106. The data logs may be collected and stored in a common store by the audit system 202 as described previously. Alternatively, the audit system 202 may provide access to different logs maintained by multiple entities, such as access to retrieve the log data over the network 110 that is stored by DHCP servers 104 and/or authentication services 106. In this approach, the log data may be accessed and retrieved on demand from remote servers/storage locations over the network 110. Thus, the audit system may not necessarily maintain a common data store is some embodiments.

One way in which the analysis tool 208 may be employed is to search data logs based on search criteria input via the analysis tool. Search criteria selected may include but is not limited to specifying one or more of an IP address, MAC address, host name, and/or user name/account ID. Other filters for a search may also be selected in some scenarios, such as selecting a particular subnet or subdomain and/or specifying particular sources of authentication data. In addition, a time period for the search (e.g., search start time and end time) may be specified.

The search is conducted based on the search criteria (block 404). For given search criteria, the analysis tool 208 operates to find as much related activity as possible from available sources such as the example DHCP server 104, domain controllers 204, and RADIUS servers 206 described herein. The way in which the search proceeds may be different depending upon the particular search criteria that is selected. In general, search results may be obtained as a combination of “direct matches” for the input search criteria with “related logs” that are discovered by correlating records based on DHCP lease activity.

As shown in FIG. 4, a search per block 404 may involve finding records that directly match the search criteria (block 406). This may occur by examining available logs to match records to the input criteria. Thus, if an IP address is specified, records that match the IP address are returned. The direct matching occurs substantially in the same manner for different selected search criteria.

In addition, related logs may be found by deriving lease chunks for a time period specified by the search criteria (block 408) and obtaining correlated results for each of the derived lease chunks (block 410). As mentioned, lease chunks correspond to particular time periods in which an IP address was consumed by a device. For example, a lease chunk may be defined by a time period between a new lease event and a corresponding release/expire/delete lease event. The manner of determining the lease chunks may vary depending on the search criteria as discussed in greater detail in relation to example scenarios for different search criteria provided below. Once lease chunks are derived, correlated results may be obtained by mapping the lease chunks to authentication records and/or other available log entries based upon one or more common elements, which may include one or more of a IP address, MAC address, user name, or host name.

Results of the search are output for display (block 412). The results may include a combination of the directly matched records and records that are determined through the correlation just described. As mentioned, the results may be formatted as a list of tuples that correlate particular users/accounts/authentication events to IP addresses/lease events. The results may be output for display via a user interface of the analysis tool 208. Results may also be provided in other forms, such as a printout or as a report that is sent to designated recipients (e.g., network administrators).

In the preceding example, the correlation occurs responsive to a specific search input by a user. In another approach, the audit system 202 may be configured to perform some pre-correlation of the data so that computational time to respond to user searches on the database is reduced. For example, a network administer may configure the audit system 202 to perform specified correlations automatically on a periodic basis. The audit system 202 may then be prepared to quickly provide results on demand. In addition or alternatively, the audit system may format reports having results that may be communicated automatically to the network administer and/or other designated recipients using email, instant messaging, and/or other suitable messaging techniques.

To further illustrate the correlation techniques described previously, consider now some example scenarios to conduct a search and obtain correlated records based upon different search criteria. Generally speaking, the correlation provides a trail of the computers or devices used by a user within a specific historical time period. Broadly speaking, this may include (1) obtaining direct matches for given search criteria, (2) deriving a set of lease chunks, and (3) obtaining correlated search results from the set of lease chunks. The following provides a discussion of details regarding different scenarios in which IP Address, MAC address/host name, and user name are employed as search criteria, respectively.

### IP Address as Search Criteria:

Assume for this scenario that search criteria is selected as an IP address, which for this example is 3.3.3.1. In addition, a time period of January 1^{st} to January 7^{th} is specified. In this case, the search may proceed as follows:

Direct matches to the address 3.3.3.1 from January 1^{st} to January 7^{th} may be determined and added to the final search results. This includes matches that may be made in available data logs from DHCP servers 104, authentication services 106, and/or other sources of relevant data that is being correlated.

Then, from the DHCP server 104, each lease event corresponding to the address 3.3.3.1 is ascertained and lease chunks may be derived. For example, lease chunks may be derived for periods between (1) a new lease event and a release\delete lease event, (2) a new lease event and a renew lease event and, (3) a renew lease event and a release\delete lease event that are discovered by referencing logged events for the for the address 3.3.3.1 within the time period.

By way of example, the following may represent lease events logged for the address 3.3.3.1, where the tuple denotes (IP address, MAC address, host name, user name, log type, timestamp):

(1) (3.3.3.1, 00aaaabbbbcc, HostA, null, New Lease, 1st January)

(2) (3.3.3.1, 00aaaabbbbcc, HostA, null, Renew Lease, 2nd January)

(3) (3.3.3.1, 00aaaabbbbcc, HostA, null, Release Lease, 3rd January)

(4) (3.3.3.1, 00ccccccaaaa, HostB, null, New Lease, 4th January)

(5) (3.3.3.1, 00ccccccaaaa, HostB, null, Renew Lease, 5th January)

(6) (3.3.3.1, 00ccccccaaaa, HostB, null, Release Lease, 6th January)

From the above example lease activity events logged by the DHCP server, the analysis tool 208 may operate to derive the following pairs as different lease chunks: (1,2) (2,3) (4,5) (5,6). The analysis tool 208 may process the lease chunks in turn to get corresponding correlated results for each lease chunk.

By way of example, consider the lease chunk (1,2) above, which is defined by the logged events (3.3.3.1, 00aaaabbbbcc, HostA, null, New Lease, 1st January) and (3.3.3.1, 00aaaabbbbcc, HostA, null, Renew Lease, 2nd January). In this case, obtaining the corresponding correlated results involves examining available logs from available sources (e.g., DHCP servers 104, domain controllers 204, RADIUS servers 206, etc.) to discover records that match one or more of the IP address=3.3.3.1, MAC address=00aaaabbbbcc, or host name=HostA within the time period of January 1^{st} to January 2nd.

Note that the log records that match host name=HostA may have a different value for the corresponding IP Address like 3ffe::1 in dual-stack environments. To handle such dual stack scenarios, handling is performed to go back in time to capture additional related records. For example, the analysis tool 208 may be configured to look back a configurable time period from the start date of the search to find IP addresses which are associated with Host A. In this example, for instance the analysis tool 208 may look back 14 days from January 1^{st} and find addresses for Host A. The IP addresses that are associated with the host in the configurable time period are picked-up and events for the addresses within the search time frame (January 1^{st} and January 2^{nd}) are added to the results. Now, even though the search criteria is 3.3.3.1, results for corresponding IP addresses (e.g., 3ffe::1) in dual-stack environments are also correlated and can be added to the results.

The process just described for the lease chunk (1,2) may be repeated for each of the lease chunks and the results are the combined for output to the user.

### MAC Address/Host Name as Search Criteria

The process used for a MAC address or host name search is similar to using the IP address as search criteria as just discussed, except that MAC address or host name are used for getting direct matches and for producing lease chunks. In particular, direct matches may be determined by finding matches in available logs using the MAC address or host name as appropriate. The direct matches are added to the final results.

Lease chunks are again obtained from the DHCP event logs by matching with the MAC address or host name as specified in the selection of the search criteria. From the lease chunks, correlated search results are obtained in substantially the same manner as described for an IP address search above and the correlated results are added to the final results.

### User Name as Search Criteria

For the most part, the process used for user name is also similar to using the IP address as search criteria, except the procedure for deriving the lease chunks from the specified “user name” criteria is different as described in detail below. In particular, direct matches may once again be determined by finding matches in available logs using the user name and the direct matches are added to the final results.

DHCP lease chunks are derived based on the specified user name criteria using a different process than in the preceding examples. Here, the user name is used to find chunks where the IP address associated with the user name has a machine authentication event within the lease chunk and such that the lease chunk has the same host as the machine authentication event. In other words, a lease chunk is found that covers the user authentication and a corresponding machine authentication with the same host name. This is further illustrated by the following example.

Consider the example tuples below that may be logged in an example scenario:

(1) (3.3.3.1, 00aaaabbbbcc, HostA, null, DHCP New Lease, 1st January 3 pm)

(2) (3ffe::1, null, HostA, null, DC Machine Authentication, 1st January 5 pm)

(3) (3ffe::1, null, null, UserA, DC User Authentication, 1st January 6 pm)

(4) (3.3.3.1, 00aaaabbbbcc, HostA, null, DHCP Renew Lease, 1st January 8 pm)

Now, if the search criteria is “UserA”, the analysis tool 208 may operate to find a lease chunk such that the IP Address associated with UserA has a “machine authentication” event within the same lease chunk, and the lease chunk has the “same host” as the machine authentication event. Using the example tuples above, the association may be made in the following manner. The user authentication event (of UserA) happens at 6 pm, with an IP Address 3ffe::1. The machine authentication event (of HostA) happens at 5 pm with the same IP Address 3ffe::1. Now there is a lease chunk which includes HostA, which covers the above time period of these events (6 pm and 5 pm). Thus, the lease chunk will be added as a lease chunk for the correlation. In particular the lease chunk is defined by the logged events:

(3.3.3.1, 00aaaabbbbcc, HostA, null, DHCP New Lease, 1st January 3 pm)

(3.3.3.1, 00aaaabbbbcc, HostA, null, DHCP Renew Lease, 1st January 8 pm)

Notice that the Host Name “HostA” is the same as for the machine authentication event (2) above and that the IP address of 3ffe::1 of the user authentication event (3) is the same for the machine authentication event (2). Thus, the lease chunk meets the enumerated criteria and is therefore derived as a chunk. From the lease chunks derived based on user name in this way, correlated search results are obtained in substantially the same manner as described for an IP address search above and the correlated results are added to the final results.

Having considered some example procedures, consider now a discussion of an example computing system that can be employed to implement various techniques for correlating users to IP address lease events in one or more embodiments.

### Example Computing System

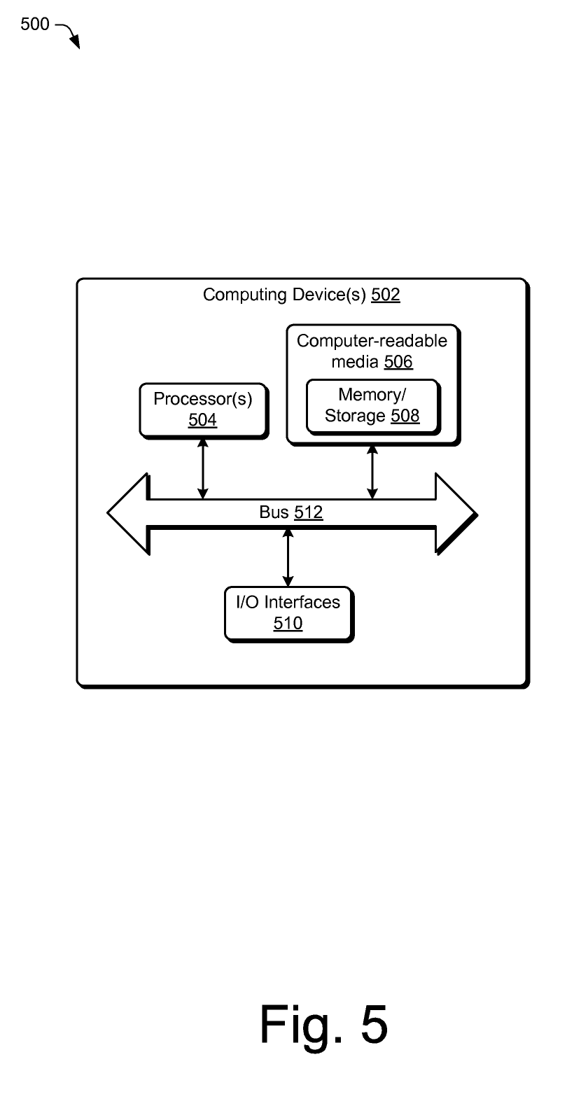

FIG. 5 illustrates an example system generally at 500 that includes an example computing device 502 that is representative of one or more such computing systems and/or devices that may implement the various embodiments described above. The computing device 502 may be, for example, a server of a service provider 108, authentication service 106, or DHCP server 104, a client device 102, a system on-chip, and/or any other suitable computing device or computing system.

The example computing device 502 includes one or more processors 504 or processing units, one or more computer-readable media 506 which may include one or more memory and/or storage components 508, one or more input/output (I/O) interfaces 510 for input/output (I/O) devices, and a bus 512 that allows the various components and devices to communicate one to another. Computer-readable media 506 and/or one or more I/O devices may be included as part of, or alternatively may be coupled to, the computing device 502. The bus 512 represents one or more of several types of bus structures, including a memory bus or memory controller, a peripheral bus, an accelerated graphics port, and a processor or local bus using any of a variety of bus architectures. The bus 512 may include wired and/or wireless buses.

The one or more processors 504 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. The memory/storage component 508 represents memory/storage capacity associated with one or more computer-readable media. The memory/storage component 508 may include volatile media (such as random access memory (RAM)) and/or nonvolatile media (such as read only memory (ROM), Flash memory, optical disks, magnetic disks, and so forth). The memory/storage component 508 may include fixed media (e.g., RAM, ROM, a fixed hard drive, etc.) as well as removable media (e.g., a Flash memory drive, a removable hard drive, an optical disk, and so forth).

Input/output interface(s) 510 allow a user to enter commands and information to computing device 502, and also allow information to be presented to the user and/or other components or devices using various input/output devices. Examples of input devices include a keyboard, a touchscreen display, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software, hardware (fixed logic circuitry), or program modules. Generally, such modules include routines, programs, objects, elements, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may include “computer-readable storage media” and “communication media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. Computer-readable storage media also includes hardware elements having instructions, modules, and/or fixed device logic implemented in a hardware form that may be employed in some embodiments to implement aspects of the described techniques.

The computer-readable storage media includes volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, hardware elements (e.g., fixed logic) of an integrated circuit or chip, or other storage device, tangible media, or article of manufacture suitable to store the desired information and which may be accessed by a computer.

“Communication media” may refer to a signal bearing medium that is configured to transmit instructions to the hardware of the computing device, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

Combinations of any of the above are also included within the scope of computer-readable media. Accordingly, software, hardware, or program modules, including the resources 112, services, device applications, analysis tool 208, and other program modules, may be implemented as one or more instructions and/or logic embodied on some form of computer-readable media.

Accordingly, particular modules, functionality, components, and techniques described herein may be implemented in software, hardware, firmware and/or combinations thereof. The computing device 502 may be configured to implement particular instructions and/or functions corresponding to the software and/or hardware modules implemented on computer-readable media. The instructions and/or functions may be executable/operable by one or more articles of manufacture (for example, one or more computing devices 502 and/or processors 504) to implement techniques related to correlation of users to IP address lease events, as well as other techniques. Such techniques include, but are not limited to, the example procedures described herein. Thus, computer-readable media may be configured to store or otherwise provide instructions that, when executed by one or more devices described herein, cause various techniques related to correlating users to IP address lease events.

### Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
collecting log data describing internet protocol (IP) address lease events and authentication events from multiple sources;
storing the collected data in a common data store;
correlating the IP lease events to the authentication events stored in the common data store based at least in part upon associated IP addresses.

2. The method of claim 1, wherein the correlating further comprises conducting a search of the collected data stored in the common data store based upon search criteria including at least one of a selected IP address, MAC address, host name, or user name.

3. The method of claim 2, wherein the correlating further comprises finding direct matches of records in the common data store that match the selected search criteria.

4. The method of claim 3, wherein the correlating further comprises finding related records from the collected data by:
deriving lease chunks from the collected lease events for a time period specified by the search criteria; and
mapping the lease chunks to related records in the data store based upon one or more common elements including one or more of an IP address, a MAC address, a host name, or a user name.

5. The method of claim 4, further comprising combining the direct matches and the related records determined through the search to produce correlated results for output to a user.

6. The method of claim 2, wherein the search comprises a search for a particular IP address specified by the search criteria, the search including:
finding records of the lease events and authentication events that directly match the specified IP address from the log data;
examining the lease events to derive lease chunks for a time period specified for the search; and
querying the authentication events to discover related records for the lease chunks that match one or more common elements including the IP address, MAC address, host name, or user name.

7. The method of claim 1, wherein correlating the IP lease events to the authentication events provides a comprehensive record for each particular IP address utilized by computing devices in a network that identifies a corresponding user name or account identifier associated with activities in the network conducted using the particular IP address.

8. The method of claim 1, wherein the multiple sources comprise a dynamic host configuration protocol (DHCP) server that maintains a log of the .lease events and one or more domain controllers and one or more RADIUS servers that maintain logs of respective authentication events.

9. One or more computer readable storage media storing instructions that, when executed by one or more components of a computing system, implement an analysis tool for an audit system configured to perform operations including:
accessing lease events recorded in an internet protocol (IP) address event log of a dynamic host configuration protocol (DHCP) server in connection with allocation of IP addresses to client devices by the DHCP server;
retrieving authentication events recorded in authentication logs by one or more sources of authentication data;
receiving search criteria to conduct a correlation of the lease events and the authentication event; and
correlating the lease events with the authentication events based on the search criteria including: finding direct matches of records using the search criteria and related records discovered based upon lease chunks that are derived from the lease events within a time period specified by the search criteria.

10. One or more computer readable storage media as described in claim 9, further comprising storing the accessed lease event and retrieved authentication events in a common data store upon which the analysis tool operates to perform the correlating.

11. One or more computer readable storage media as described in claim 9, wherein, the one or more sources of authentication data comprise a domain controller.

12. One or more computer readable storage media as described in claim 9, wherein the one or more sources of authentication data comprise a RADIUS server.

13. One or more computer readable storage media as described in claim 9, wherein the correlating further comprises deriving the lease chunks by examining the lease events within a specified time frame to discover distinct lease chunks defined by a new lease event and a release lease event, a renew lease event and a release lease event, or a new lease event and a renew lease event.

14. One or more computer readable storage media as described in claim 9, wherein finding related records further comprises searching within the lease chunks to find matching records based upon one or more of an IP address, a MAC address, a host name or a user name.

15. A computing system comprising:
one or more processors;
one or more computer readable storage media;
an analysis tool stored on the one or more computer readable storage media and executable via the one or more processors to perform operations including:
receiving a selection of search criteria to search data logs describing internet protocol (IP) address lease events and authentication events;
conducting a search of the data logs based on the search criteria to correlate the IP address lease events with the authentication events; and
outputting results of the search for display to a user, the results correlating the IP address lease events with the authentication events to identify user names or account identifiers associated with the IP address lease events.

16. The computing system as described in claim 15, wherein the search criteria comprises a selected IP address.

17. The computing system as described in claim 15, wherein the search criteria comprises at least one of a selected Media Access Control (MAC) address, a host name, or a user name.

18. The computing system as described in claim 15, wherein conducting the search based on the search criteria further comprises:
finding records that directly match the search criteria;
deriving lease chunks for a time period specified by the search criteria; and
obtaining correlated results for each of derived lease chunks by searching within the lease chunks to find records that match one or more of an IP address, a MAC address, a host name, or a user name.

19. The computing system as described in claim 15, further comprising:
collecting the data logs over a network including collecting an IP address lease event log from a dynamic host configuration protocol (DHCP) server and authentication logs from one or more authentication services;
storing the collected data logs in a common data store; and
accessing the data logs from the common data store to conduct the search.

20. The computing system as described in claim 15, wherein conducting the search comprises:
accessing an IP address lease event log from a DHCP server and authentication logs from one or more authentication services over a network; and
examining the lease events from the IP address lease event log and authentication events from the authentication logs on demand in response to the selection of the search criteria.
